(19) United States
(12) Patent Application Publication
(10) Pub. No.: US 2006/0288602 A1
(43) Pub. Date: Dec. 28, 2006

(54) Heat exchanger for dryer and condensing type dryer using the same

(75) Inventors: Hyun-Uk Lee, Gyeongsangnam-Do (KR); Jung-Geun Oh, Gyeongsangnam-Do (KR); Yoon-Seob Eom, Changwon (KR)

Correspondence Address: FLESHNER & KIM, LLP, P.O. BOX 221200, CHANTILLY, VA, 20153, US

(73) Assignee: LG Electronics Inc.

(21) Appl. No.: 11/444,437

(22) Filed: Jun. 1, 2006

(30) Foreign Application Priority Data
Jun. 4, 2005 (KR) 10-2005-48092
Jun. 14, 2005 (KR) 10-2005-51103

(51) Int. Cl. F26B 19/00

(52) U.S. Cl. 34/86

(57) ABSTRACT

A heat exchanger for a dryer includes a plurality of tube units configured to conduct warm humid air and a plurality of fin units configured to conduct a flow of ambient air. The tube units and fin units are alternately stacked to form a core. The fin units includes a plurality of air channels formed by repeatedly bending a flat metal plate in a zigzag fashion and a plurality of fins formed on surfaces of the air channels. The tube units have a duct form with both ends opened. The tube units may be formed by extrusion. A plurality of channel walls can be formed inside the tube units. A plurality of grooves or fins can also be formed inside the tube units. A plurality of channel walls can also be vertically formed inside the tube units. In this case, the grooves or fins can be formed on the channel walls. The grooves or fins can also be formed in a spiral form on the inner surfaces of the tube units.

### BACKGROUND OF THE INVENTION

1. Field of the Invention

The present invention relates to a heat exchanger for a dryer and, more particularly, to a heat exchanger with a new structure capable of improving heat transfer efficiency.

2. Description of the Related Art

In general, a dryer dries clothes by blowing a flow of hot air generated by a heater into a drum. Dryers can be divided into exhaust type dryers and condensing type dryers depending on the method used for processing the humid air generated by the dryer. In the, exhaust type dryer, humid air exhausted from a drum is discharged to outside of the dryer. In the condensing type dryer, humid air discharged from the drum is condensed to remove moisture and the dried air is transferred back to the drum again so as to be re-circulated.

The condensing type dryer includes a drum is for drying the laundry, a filter for filtering out foreign materials, a heat exchanger (or condenser) for removing moisture from the laundry through heat exchange, a fan for facilitating drying by generating an air flow, a heater for heating the flow of air to shorten the drying time, and piping for connecting the components.

FIGS. 1a and 1b show an example of the condensing type dryer. As shown in FIGS. 1a and 1b, an arrow I indicates a flow of external air and an arrow II indicates a flow of air that recirculates through the drum. A drum 11 in which clothes are received is rotatably installed inside a main body 10, and a door 12 is installed at a front side of the main body 10. The drum 11 is rotated by a belt 19 and a motor 17 installed at a lower portion of the main body 10.

A heat exchanger (or condenser) 13 is installed at the lower portion of the main body 10 and condenses hot and humid air circulated through the drum 11 to remove moisture from the air. Front and rear sides of the heat exchanger 13 are connected with a circulation duct 14 connected with both front and rear sides of the drum 11. When air is discharged through the drum 11, it can be introduced again into the drum 11 after passing through the heat exchanger 13. A heater 15 for heating air which has passed through the heat exchanger 13 and a circulation fan 16 for forcibly circulating air through the circulation duct 14 are installed at the circulation duct 14. The circulation fan 16 is connected with a different shaft of the motor 17 that also drives the drum 11.

In order to condense water from the air passing through the heat exchanger 13, external cold air must be supplied to the heat exchanger 13. For this purpose, an external air supply duct 18 connected with an outer side of the main body 10 is connected with one side of the heat exchanger 13. A cooling fan 20 for forcibly sucking external air through the external air supply duct 18 and discharging it into the main body 10 and a cooling fan driving motor 21 are installed at the opposite side of the heat exchanger 13. Reference numeral 22 is a filter for filtering out foreign materials such as waste thread or the like from the air exhausted to the circulation duct 14 through the front side of the drum 11. A water receiver (not shown) for collecting condensed water generated during a condensing process is installed at a lower side of the heat exchanger 13. A pump 23 for sending the condensed water collected in the water receiver to a storage tank 2 is also installed at the lower side of the heat exchanger 13.

The purpose of the dryer is to dry laundry quickly with as low a power consumption as possible. To shorten the laundry drying time, a method for increasing a capacity of the heater or the fan has been considered. However, doing so adds additional cost to the dryer, and electrical charges increase because of an increase in the power consumption. Noise may also increase.

FIG. 2 shows an example of a heat exchanger that can be used in a condensing type clothes dryer or a washing machine that includes a drying function. The heat exchanger includes an external air inflow unit 13a and a humid air inflow unit 13b. Humid air from the drum of the dryer that enters the humid air inflow unit 13b transfers heat to ambient air that is introduced into the external air inflow unit 13a. As a result, water from the humid air condenses on inner surfaces of the heat exchanger. In the condensing type dryer, the heat exchanger is a core component playing an important role for the drying efficiency.

### BRIEF DESCRIPTION OF THE INVENTION

One object of the present invention is to provide a heat exchanger structure capable of increasing an efficiency of heat exchange.

Another object of the present invention is to fabricate a heat exchanger using an inexpensive method.

Still another object of the present invention is to enhance drying efficiency and product reliability of a dryer or a washing machine that includes a drying function.

To implement at least the above objects in whole or in part, a heat exchanger embodying the invention includes a plurality of tube units for conducting a flow of warm humid air and a plurality of fin units for conducting a flow of ambient air. The tube units and fin units are alternately stacked to form a core of the heat exchanger. The fin units include a plurality of air channels formed by repeatedly bending a flat metal plate in a zigzag fashion. A plurality of fins may be formed along surfaces of the air channels.

The tube units may have a duct form with both ends opened. Multi-channel tube units can be constructed by forming a plurality of channel walls in the tubes. In this case, preferably, the channel walls are formed integrally with the tubes. To have better heat transmission characteristics, preferably the tube units have a thickness smaller than the fin units.

In some embodiments of the invention, the tube units may include a plurality of grooves formed therein to increase the turbulence of the air flowing through. The increased turbulence increases the efficiency of the heat exchange. If the tube units include interior channel walls, the grooves may be formed on the inner surface of the channel walls. The grooves can also be spirally formed on inner surfaces of the tube units.

Fins can also be formed on interior channel walls. The fins can also be spirally formed on the inner surfaces of the tube units.

Preferably, the tube units and fin units are made of a metal or an alloy with a high heat transfer rate. Aluminum can be suitably used, but the present invention is not limited thereto.

A heat exchanger embodying the present invention can be used in a condensing type dryer or a washing machine that includes a drying function. The heat exchanger serves to improve drying efficiency, to reduce power consumption, and to lower the overall cost of the product.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings, in which like reference numerals refer to like elements, and wherein:

FIG. 1a is a sectional view showing an example of a clothes dryer;

FIG. 1b is a plan view of the clothes dryer in FIG. 1;

FIG. 2 is a perspective view showing an example of a heat exchanger;

FIG. 3 is an exploded view showing components of a heat exchanger according to the present invention;

FIG. 4a is a sectional view showing a metal plate for shaping tube units;

FIG. 4b is a sectional view showing a tube unit formed by bending the metal plate of FIG. 4a;

FIG. 5 is a sectional view showing a tube unit according to another embodiment of the present invention;

FIG. 6 is a sectional view showing an example of a bonding structure of tube units and fin units;

FIG. 7 is a sectional view showing a bonding structure of tube units and fin units according to another embodiment of the present invention;

FIG. 8 is a sectional view showing a tube unit according to another embodiment of the present invention;

FIG. 9 is a photo of a portion of a heat exchanger according to the present invention;

FIGS. 10a and 10b are sectional views showing a tube unit structure according to an embodiment of the present invention;

FIG. 11 is a sectional view showing a tube unit structure according to still another embodiment of the present invention;

FIG. 12 is a sectional view showing a tube unit structure according to still another embodiment of the present invention;

FIGS. 13a and 13b show a tube unit structure according to still another embodiment of the present invention;

FIG. 14a is a sectional view showing a tube unit structure according to still another embodiment of the present invention;

FIG. 14b is a perspective view showing channel walls formed inside the tube unit in FIG. 14a; and

FIG. 15 is a perspective view showing a tube unit structure according to still another embodiment of the present invention.

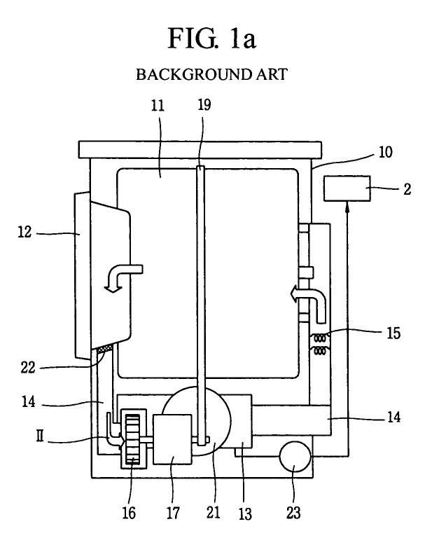

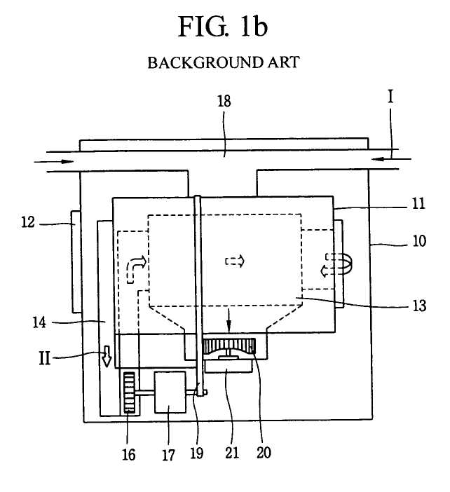

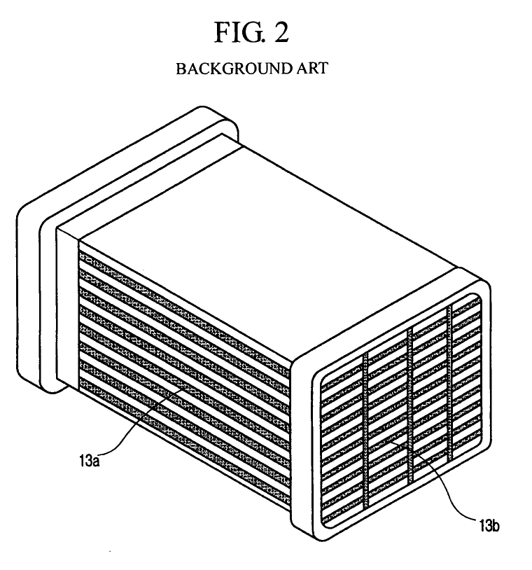

### DETAILED DESCRIPTION OF THE INVENTION

The present invention will be described in detail with reference to the accompanying drawings.

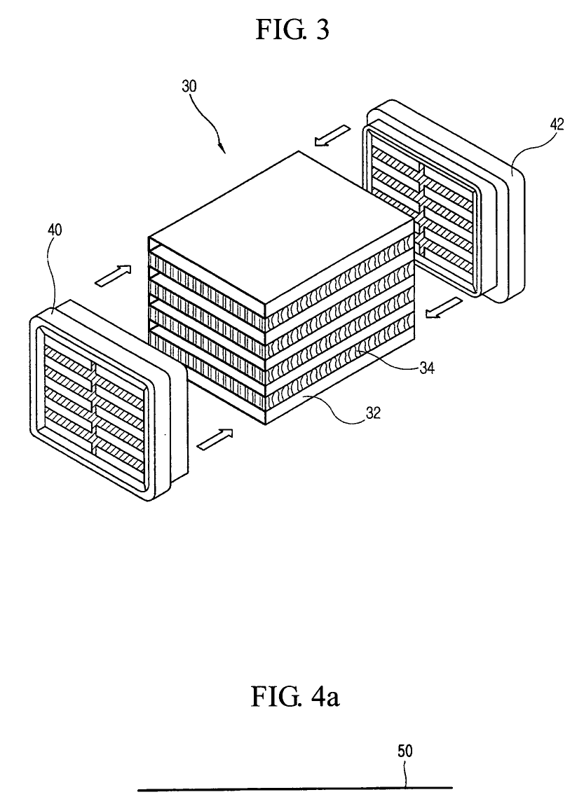

The structure of a heat exchanger for a dryer will be described. With reference to FIG. 3, in the heat exchanger, a plurality of tube units 32 and a plurality of fin units 34 are alternately stacked, to form a core. A front cover 40 and a rear cover 42 are formed by injection molding, and are coupled at both ends of the heat exchanger 30, respectively.

The tube units 32 have a duct structure and both ends are opened. The tube units 32 may have a rectangular cross-sectional shape. The fin units 34 are formed by bending a metal plate in a zigzag fashion. A plurality of fins may be formed on the walls of this structure.

The tube units 32 serve as a passage through which internal circulative humid air may flow The fin units are configured to conduct a flow of external dry air. Portions of the tube units and fin units are in contact with each other so that heat from the air in the tube units can be transferred to the air in the fin units. The tube units 32 and the fin units are preferably made of a metal material having excellent heat transfer characteristics, for which aluminum is typically used.

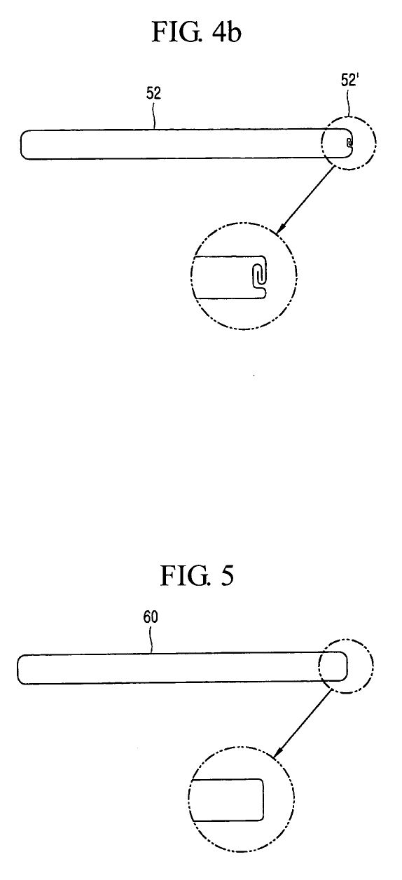

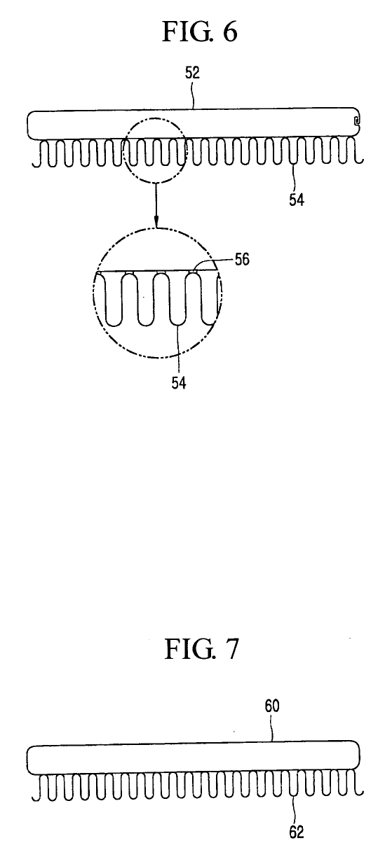

In one example of a method for shaping the tube units, a metal plate 50 as shown in FIG. 4a, is bent into a rectangular form like a duct. The ends are seamed so that they can be jointed. FIG. 4b shows a tube 52 which is a metal plate bent to the form of the duct. Both ends of the metal plate are bent to overlap with each other at the joint 52′ as shown in an enlarged view indicated in a circle. However, because each tube must be bent one by one, a problem of mass-production arises. In addition, the joint 52′ cannot completely prevent leakage of condensed water which is generated in a heat exchange unit.

In a preferred embodiment of the present invention, economical efficiency in the tube shaping process is obtained. Also, the tube structure and the shaping method are improved such that condensed water generated during a heat exchange process will not be leaked. With reference to FIG. 5, a tube 60 is integrally formed without a joint. This form can be obtained by extruding a tube material under a high pressure condition or under a high temperature condition.

Integral formation of the tube structure according to extrusion, without a joint, can not only prevent a leakage of condensed water from the side of the tube but also solve a problem in that when a plate is bent to form a tube, the thickness of each tube may not be uniform because of the bending process. In addition, a considerably long tube structure can be formed at one time through extrusion. The long tube can then be cut into a plurality of shorter tubes, which helps to improve mass productivity.

As noted above, the tube units and the fin units of the heat exchange core are in contact with each other for transferring heat. The core can be assembled by epoxy bonding the tube units 52 and the fin units 54. However, epoxy bonding takes much time to perform, and epoxy itself is a poisonous material, so it is not good in terms of mass production. In addition, generally, an epoxy layer 56 formed at the juncture between the tube 52 units and the fin units 54 has a thickness of about 0.5 mm, which results in poor heat transfer characteristics, thus deteriorating the overall heat exchange efficiency of the heat exchange unit.

In the present invention, a bonding process is performed without using a low heat transfer material such as epoxy for coupling the tube units 60 and the fin units 62. In the present invention, a brazing process is used to couple the tube units and the fin units. The brazing process is advantageously performed such that metals are bonded instantaneously at a high temperature with a very thin metal bonding medium. The time required for bonding can be considerably reduced compared to bonding with an epoxy. In addition, the metal material used in the brazing process does not degrade the heat transfer efficiency between the tube units and fin units. FIG. 7 is a schematic view showing a bonding structure of a tube unit 60 and a fin unit 62 which has a very thin metallic bonding medium layer at a juncture portion.

In the brazing process, if the tube units 60 and the fin units 62 are made of aluminum, a metal material having a melting point lower than that of aluminum is used as the bonding medium. The tube units 60 and the fin units 62 are heated to a temperature lower than the melting point of aluminum, but higher than the melting point of the bonding medium. This melts the bonding medium. The devices then cool, which causes the bonding medium to re-solidify, thus bonding the tube units to the fin units. Through this process, the tube units 60 and the fin units 62 can be completely bonded to form the core within a short time (typically about two minutes). After the process is finished, very little of the bonding medium remains between the tube units and the fin units, which helps to retain good heat transfer characteristics at the contact portions of the heat exchange unit.

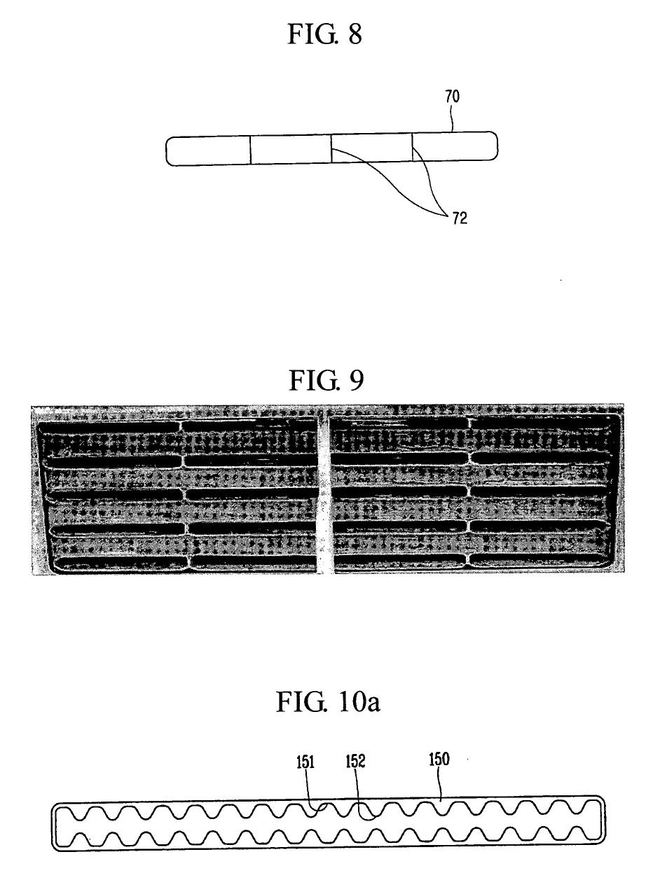

In a different embodiment of the present invention, the strength in the thickness direction of the tube is reinforced to help maintain the thickness of the tube more uniformly. With reference to FIG. 8, a plurality of channel walls 72 are formed inside an integrally formed tube 70 without a joint. The channel walls 72 are formed at equal intervals in the tube 70 to distribute force in the thickness direction of the tube uniformly, thereby helping to prevent a change in the thickness.

Preferably, the channel walls 72 can be integrally formed through the extrusion process used to form the tube 70. When the channel walls 72 and the tube 70 are integrally formed, the space inside the tube 70 can be divided into several channels to increase a probability that flowing air transfers heat, so an overall heat exchange efficiency can be improved.

FIG. 9 is a photo showing an actually fabricated tube shape. It is noted that the tube units are integrally formed through extrusion without a joint, and a plurality of channel walls are formed inside the tube. The plurality of channel walls formed inside the tube serve to support the tube in the thickness direction so as not to generate a bent portion of the tube. In addition, the plurality of channel walls dividing the inner space of the tube into a plurality of channels not only serve to support the tube but also serve as a medium for heat transfer by themselves to thus effectively increase heat transfer at the upper and lower portions of the tube.

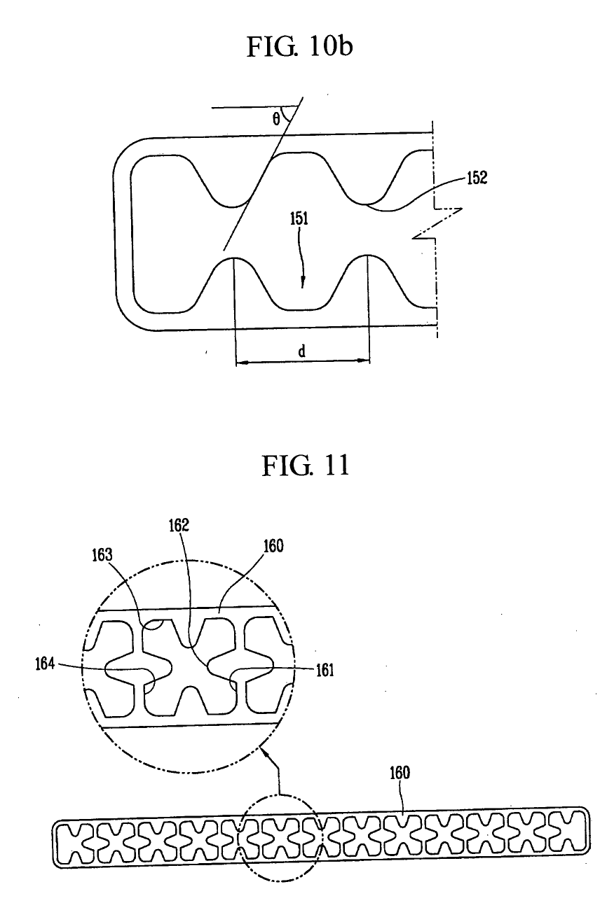

A heat exchanger according to another embodiment of the present invention will now be described. FIG. 10a shows a sectional structure of a tube unit 150 according to the second embodiment of the present invention. A plurality of grooves 151 are formed on the inner surface of the tube 150. The grooves 151 can be formed by forming recesses on the inner surfaces of the tube 150 or by additionally forming protrusions 152. The grooves 151 can cause air (namely, internal circulative humid air in a dryer) flowing inside the tube to become a turbulent. The turbulent flow increases a possibility of contacting with the internal surfaces of the tube. As a result, the heat transfer to external dry air can be further increased inside the heat exchanger, so the heat exchanger efficiency can be further improved. The grooves or the protrusions can be formed by etching the surface of a tube made of a metal material, or by shaping methods such as extrusion.

In a tube structure with grooves formed on the internal surfaces thereof, an important factor impacting the heat transfer characteristics are the intervals between grooves and the form of the grooves. FIG. 10b shows an enlarged view of a portion of the tube. The intervals (d) between grooves 151 (or the protrusions 152) formed on the inner surfaces of the tube should be not too large or small. Preferably, the interval is within the range of 1˜3 mm. If the interval is too narrow, shaping is not easy and a problem of noise unnecessarily generated by the air flow may arise. If the interval is too wide, the air flow does not become turbulent enough to increase the heat transfer characteristics of the tube units.

The grooves 151 can have a concave semi-circular shape or a rectangular shape, but the present invention is not limited thereto. When factors such as abrasion of air flowing inside the tube, the air flow speed, and the heat transfer, etc. are taken into consideration, it is preferred that the grooves 151 have a certain slope angle θ with respect to the surface of the tube. Preferably, the slope angle θ of the grooves is within the range of 30 degrees to 50 degrees.

FIG. 11 shows another example of the tube structure. As shown, a plurality of channel walls 161 are formed inside the tube 160 to section the interior of the tube into several spaces. A plurality of protrusions 162 are formed on the inner surface and on the channel walls 161. Accordingly, a plurality of grooves 163 and 164 are formed on the inner surfaces and on the channel walls 161. Because the plurality of grooves are formed on the inner surfaces and channel walls of the tube, turbulent flow is created to increase possibility of heat transfer. The heat transfer area of the tube is also increased, and thus, the heat exchange efficiency of the heat exchanger can be considerably increased.

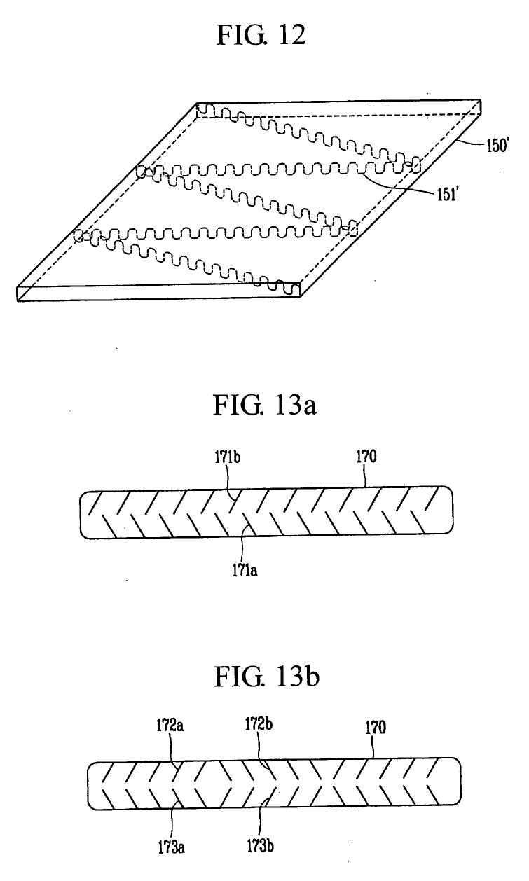

FIG. 12 shows another embodiment of the present invention. As shown, a plurality of grooves 151′ are formed in a spiral form on the inner surface of a tube 150′. The spirally formed grooves 151′ cause air flowing inside the tube 150′ to form a turbulent flow, but air is still allowed to quickly flow without a delay in flowing in the tube according to the spiral flow rate. Thus, in the heat exchanger, the heat transfer can be increased and the air flow can become fast to enhance the efficiency of the heat exchanger.

FIG. 13a shows another example of a tube structure 170 according to the present invention. In this embodiment, a plurality of fins 171a and 171b are formed inside the tube 170. The fins 171a and 171b are directly formed on upper and lower surfaces of the tube with approximately the same slope direction. In an alternate embodiment shown in FIG. 13b, the upper fins 172a and 172b can have different slope directions, or the lower fins 173a and 173b can have different slope directions, all of which helps to promote stirring of air flowing inside the tube 170.

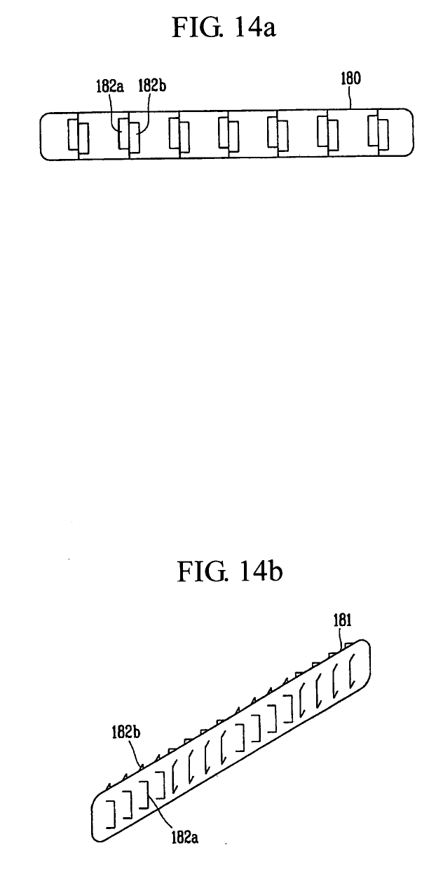

FIGS. 14a and 14b show another embodiment of a tube structure embodying the invention. In this embodiment, walls 181 are formed between the upper and lower surfaces of the tube 180. A plurality of fins 182a and 182b are formed on either side of the walls 181. The fins 182a and 182b extend into the airflow to cause the air flow to become turbulent, thereby increasing the heat transfer efficiency of the heat exchanger. The walls 181 themselves also help to transfer heat out of the air flowing through the tube 180.

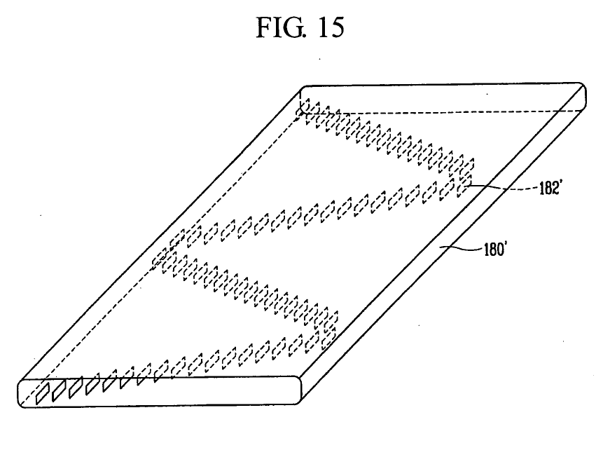

FIG. 15 shows another embodiment of the present invention. As shown, a plurality of fins 182′ are formed spirally inside a tube 180′. The spirally formed fins 182′ allow air flowing inside the tube 182′ to cause the air to form a turbulent flow. However, this structure allows air to quickly flow without a delay inside the tube according to the spiral flowing. Thus, in the heat exchanger, the heat transfer can be increased and the air flow can move fast to enhance the efficiency of the heat exchanger.

In this manner, by forming the grooves or fins inside the tube of the heat exchange unit of the heat exchanger, heat exchange efficiency can be improved. Experimentation shows that the heat transfer characteristics can be improved by more than two times by such methods.

According to the present invention, the heat transfer characteristics of a heat exchanger for a dryer can be improved and thus the heat exchange efficiency can be much increased. By enhancing the form of the tube units, productivity can be increased, and leakage of condensed water can be prevented. In addition, by enhancing the drying efficiency of the dryer or the washing machine that includes a drying function by employing the heat exchanger, power consumption can be reduced and product reliability can be improved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A heat exchanger, comprising:
a plurality of tube units configured to conduct a first flow of air, wherein each of the tube units has opened ends, and wherein each tube unit is formed by an extrusion process such that sidewalls that define the tube unit are seamless; and
a plurality of fin units configured to conduct a second flow of air, wherein the plurality of fin units and the plurality of tube units are alternately stacked to form a core of the heat exchanger.

2. The heat exchanger of claim 1, wherein each of the tube units further comprises a plurality of channel walls located inside the tube unit, wherein the channel walls extend in the longitudinal direction of the tube unit and are vertically oriented.

3. The heat exchanger of claim 2, wherein the channel walls are formed integrally with the tube units.

4. The heat exchanger of claim 1, wherein each of the tube units has a thickness that is smaller than a thickness of each of the fin units.

5. The heat exchanger of claim 1, wherein each of the fin units comprises a plurality of air channels that are formed by repeatedly bending a metal plate in a zigzag fashion.

6. The heat exchanger of claim 5, wherein fins are formed on surfaces of the plurality of air channels.

7. A dryer comprising the heat exchanger of claim 1.

8. A heat exchanger, comprising:
a plurality of tube units configured to conduct a first flow of air, wherein each of the tube units has opened ends, and wherein each of the tube units further comprises a plurality of channel walls that are located inside the tube unit, wherein the channel walls extend in the longitudinal direction of the tube unit and are vertically oriented; and
a plurality of fin units configured to conduct a second flow of air, wherein the plurality of fin units and the plurality of tube units are alternately stacked to form a core of the heat exchanger.

9. The heat exchanger of claim 8, wherein each of the fin units comprises a plurality of air channels that are formed by repeatedly bending a metal plate in a zigzag fashion.

10. The heat exchanger of claim 9, wherein fins are formed on surfaces of the plurality of air channels.

11. The heat exchanger of claim 8, wherein the channel walls are configured to increase a rigidity of the tube units.

12. The heat exchanger of claim 8, wherein a plurality of fins are formed on surfaces of the channel walls.

13. The heat exchanger of claim 12, wherein the fins on single sidewall of one of the channel walls extend in different directions.

14. The heat exchanger of claim 8, wherein the plurality of channel walls are formed in a spiral fashion inside the tube units.

15. A dryer comprising the heat exchanger of claim 8.

16. A heat exchanger, comprising:
a plurality of tube units configured to conduct a first flow of air, wherein each of the tube units has opened ends, and wherein each of the tube units further comprises a plurality of fins that are formed on at least one inner surface of the tube unit; and
a plurality of fin units configured to conduct a second flow of air, wherein the plurality of fin units and the plurality of tube units are alternately stacked to form a core of the heat exchanger.

17. The heat exchanger of claim 16, wherein the fins are formed on two opposing inner surfaces of each of the tube units.

18. The heat exchanger of claim 17, wherein the fins on the opposing inner surfaces of the tube units all extend in the same direction.

19. The heat exchanger of claim 17, wherein the fins on a first of the inner surfaces extend in a first direction, and wherein the fins on a second of the inner surfaces extend in a second different direction.

20. The heat exchanger of claim 16, wherein the fins on one inner surface of each of the tube units extend in multiple different directions.

21. A dryer comprising the heat exchanger of claim 16.

22. A heat exchanger, comprising:
a plurality of tube units configured to conduct a first flow of air, wherein each of the tube units has opened ends, and wherein each of the tube units further comprises a plurality of cross plates that are formed on inner surfaces of the tube unit, wherein the cross plates are vertically oriented and extend in a direction that is substantially transverse to a flow direction of the first flow of air; and
a plurality of fin units configured to conduct a second flow of air, wherein the plurality of fin units and the plurality of tube units are alternately stacked to form a core of the heat exchanger.

23. The heat exchanger of claim 22, wherein a plurality of alternating projections and recesses are formed on the cross plates.

24. The heat exchanger of claim 23, wherein an interval between adjacent projections on the cross plates is between approximately 1 mm and approximately 3 mm.

25. The heat exchanger of claim 24, wherein side edges of the projections on the cross plates are oriented along a line that forms an angle of between 30 to 50 degrees with respect to the adjacent sidewall of the tube unit.

26. The heat exchanger of claim 22, wherein the plurality of cross plates are arranged in a spiral fashion inside each tube unit.

27. The heat exchanger of claim 22, wherein a plurality of apertures are formed in the cross plates.

28. The heat exchanger of claim 27, wherein the apertures are X shaped.

29. A dryer comprising the heat exchanger of claim 22.
